(19) United States
(12) Patent Application Publication
(10) Pub. No.: US 2026/0307466 A1
(43) Pub. Date: Oct. 8, 2026

(54) THERMAL MANAGEMENT SYSTEM

(71) Applicant: Sanden Corporation, Gunma (JP)

(72) Inventor: Nobutaka SHIMIZU, Isesaki-shi (JP)

(73) Assignee: Sanden Corporation, Gunma (JP)

(21) Appl. No.: 19/481,451

(22) PCT Filed: Apr. 22, 2024
(86) PCT No.: PCT/JP2024/015685

§ 371 Date: Nov. 4, 2025

(30) Foreign Application Priority Data
May 19, 2023 (JP) 2023-083232

(51) Int. Cl. B60H 1/32; B60H 1/00

(52) U.S. Cl. CPC B60H 1/32284; B60H 1/00278; B60H 1/00392; B60H 1/00899

(57) ABSTRACT

Provided is a thermal management system with a favorable energy efficiency. A thermal management system 1 includes a refrigerant circuit 10 configured to circulate refrigerant, a high-temperature-side heat medium circuit 20 including a heater core 21 that heats air in a vehicle cabin and capable of exchanging heat with the refrigerant circuit 10, a low-temperature-side heat medium circuit 30 including a cooler core 31 that cools the air in the vehicle cabin and capable of exchanging heat with the refrigerant circuit 10, a battery temperature adjustment circuit 40 including a battery temperature adjuster that adjusts the temperature of a battery 41 and capable of exchanging heat with the refrigerant circuit 10, a motor temperature adjustment circuit 50 including a motor temperature adjuster that adjusts the temperature of a motor 51, an outdoor heat exchange circuit 60 including a radiator 61, and a channel switching device 70. The channel switching device 70 is configured to connect the motor temperature adjustment circuit 50 to any of the low-temperature-side heat medium circuit 30, the battery temperature adjustment circuit 40, and the outdoor heat exchange circuit 60 in response to at least any of a temperature adjustment request of the battery 41 and an air-conditioning request.

### TECHNICAL FIELD

The present invention relates to a thermal management system.

### BACKGROUND ART

In recent years, use of electric vehicles has increased. In the electric vehicle, the power of a battery is also used for temperature adjustment of the inside of a vehicle cabin, various in-vehicle devices, and the like. In order to ensure a sufficient travel distance by the charged battery, it is necessary to efficiently use the power. For example, Patent Literature 1 discloses a technique related to a thermal management system by a heat pump.

### CITATION LIST

### Patent Literature

Patent Literature 1: JP-A-2023-032565

### SUMMARY OF INVENTION

### Problems to be Solved by Invention

The present invention is intended to provide a thermal management system with a favorable energy efficiency.

### Solution to Problems

According to one aspect of the present invention, a thermal management system includes a refrigerant circuit configured to circulate refrigerant and including a compressor, a high-temperature-side heat exchanger, a decompression device, and a low-temperature-side heat exchanger, a high-temperature-side heat medium circuit including a heater core that heats air supplied into a vehicle cabin and configured to circulate a heat medium capable of exchanging heat with the refrigerant via the high-temperature-side heat exchanger, a low-temperature-side heat medium circuit including a cooler core that cools air supplied into the vehicle cabin and configured to circulate a heat medium capable of exchanging heat with the refrigerant via the low-temperature-side heat exchanger, a battery temperature adjustment circuit including a battery temperature adjuster that adjusts the temperature of a battery, a motor temperature adjustment circuit including a motor temperature adjuster that adjusts the temperature of a motor, an outdoor heat exchange circuit including a radiator and configured to circulate a heat medium, and a channel switching device configured to switch the low-temperature-side heat medium circuit, the battery temperature adjustment circuit, the motor temperature adjustment circuit, and the outdoor heat exchange circuit between a connection state and an independent state. At the time of startup, when the temperature of the battery is a predetermined lower limit or less, the channel switching device connects the low-temperature-side heat medium circuit and the outdoor heat exchange circuit, and connects the battery temperature adjustment circuit and the motor temperature adjustment circuit.

### Effects of Invention

According to the present invention, the thermal management system with the favorable energy efficiency can be provided.

### BRIEF DESCRIPTION OF DRAWINGS

FIG. 1 is a schematic diagram of a configuration example of a thermal management system according to one embodiment, which shows an example of the state of the thermal management system at the time of startup when an outside air temperature is low.

FIG. 2 is a schematic diagram of a configuration example of the thermal management system according to one embodiment, which shows an example of the state of the thermal management system when the outside air temperature is low and a battery is in an appropriate temperature range.

FIG. 3 is a schematic diagram of a configuration example of the thermal management system according to one embodiment, which shows an example of the state of the thermal management system when the outside air temperature is low, a heating operation cannot be performed only by exhaust heat of a motor, and the battery is in the appropriate temperature range.

FIG. 4 is a schematic diagram of a configuration example of the thermal management system according to one embodiment, which shows an example of the state of the thermal management system when the outside air temperature is low and the temperature of the battery increases and is about to exceed the upper limit of the appropriate temperature range.

FIG. 5 is a schematic diagram of a configuration example of the thermal management system according to one embodiment, which shows an example of the state of the thermal management system when defrosting of a radiator and a heating operation in a vehicle cabin are performed during traveling.

### DESCRIPTION OF EMBODIMENTS

### Configuration of System

### <Outline of System>

One embodiment will be described with reference to the drawings. The present embodiment relates to a thermal management system having a refrigerant circuit and a heat medium circuit. The thermal management system of the present embodiment is mounted on an electric vehicle, and is capable of performing air-conditioning in a vehicle cabin, temperature adjustment of a battery and other in-vehicle devices, and the like with a favorable energy efficiency. The thermal management system of the present embodiment can effectively use exhaust heat without remaining the exhaust heat by using outside air heat absorption, battery exhaust heat, and motor exhaust heat alone or in combination as a heat absorption source for a heating operation, Moreover, the thermal management system of the present embodiment can defrost a radiator using the battery exhaust heat while continuing the heating operation using the motor exhaust heat as a heat absorption source.

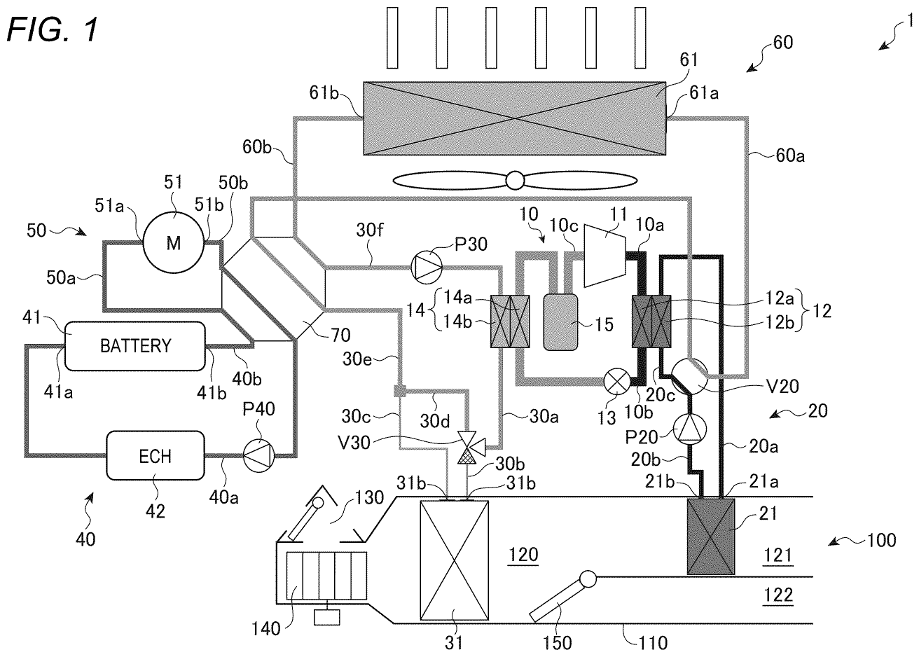

FIGS. 1 to 5 are schematic diagrams for describing a configuration example of a thermal management system 1 according to the present embodiment. The thermal management system 1 is configured such that a circuit is switched according to various operations. Each of Figs. I to 5 shows a circuit configuration during some of the various operations.

The thermal management system 1 includes a refrigerant circuit 10 configured to circulate refrigerant. The refrigerant is not limited thereto, and for example, hydrofluoroolefin or the like may be used. Further, the thermal management system 1 includes a high-temperature-side heat medium circuit 20, a low-temperature-side heat medium circuit 30, a battery temperature adjustment circuit 40, a motor temperature adjustment circuit 50, and an outdoor heat exchange circuit 60, which are configured to circulate a heat medium as fluid such as a coolant, for example. Among these circuits, the low-temperature-side heat medium circuit 30, the battery temperature adjustment circuit 40, the motor temperature adjustment circuit 50, and the outdoor heat exchange circuit 60 are connected to a channel switching device 70 such as an eight-way valve. The channel switching device 70 can couple these channels to each other to form a circulation path in which these circuits cooperate to circulate the heat medium, or disconnect one or more circuits from other circuits to independently operate these circuits. The high-temperature-side heat medium circuit 20 and the outdoor heat exchange circuit 60 are connected to a channel switching device such as a four-way valve V20 that connects or disconnects the channels to or from each other. The four-way valve V20 can form the circulation path in which the high-temperature-side heat medium circuit 20 and the outdoor heat exchange circuit 60 cooperate to circulate the heat medium, or can disconnect these circuits from each other.

Further, the thermal management system 1 includes a heating, ventilation, and air conditioning (HVAC) unit 100. In addition, the thermal management system 1 includes various sensors (not shown) and a control device that controls operation of each unit of the thermal management system 1. The operation of the thermal management system 1 is controlled based on detection values of the various sensors, various requests, and the like.

### <Refrigerant Circuit>

The refrigerant circuit 10 includes a compressor 11 that compresses gaseous refrigerant into high-temperature high-pressure refrigerant and then discharge the high-temperature high-pressure refrigerant, a high-temperature-side heat exchanger 12 that condenses the compressed gaseous refrigerant to dissipate heat, a decompression device 13, such as an expansion valve, that expands liquid refrigerant into low-pressure refrigerant, and a low-temperature-side heat exchanger 14 that evaporates the low-temperature low-pressure liquid refrigerant to absorb heat. The refrigerant circuit 10 is configured to function as a heat pump that circulates the refrigerant and repeats compression, condensation, expansion, and evaporation.

In the high-temperature-side heat exchanger 12, the refrigerant exchanges heat with the heat medium circulating in the high-temperature-side heat medium circuit 20. Moreover, in the low-temperature-side heat exchanger 14, the refrigerant exchanges heat with the heat medium circulating in the low-temperature-side heat medium circuit 30.

In the example shown in the figures, the high-temperature-side heat exchanger 12 includes a refrigerant passage 12a through which the refrigerant circulating in the refrigerant circuit 10 passes, and a heat medium passage 12b through which the heat medium circulating in the high-temperature-side heat medium circuit 20 passes. The low-temperature-side heat exchanger 14 includes a refrigerant passage 14a through which the refrigerant circulating in the refrigerant circuit 10 passes, and a heat medium passage 14b through which the heat medium circulating in the low-temperature-side heat medium circuit 30 passes.

The elements of the refrigerant circuit 10 are connected by refrigerant channels 10a, 10b, 10c. The compressor 11 is connected to the inlet of the refrigerant passage 12a of the high-temperature-side heat exchanger 12 by the refrigerant channel 10a. The outlet of the refrigerant passage 12a of the high-temperature-side heat exchanger 12 is connected to the inlet of the refrigerant passage 14a of the low-temperature-side heat exchanger 14 by the refrigerant channel 10b, and the decompression device 13 such as an expansion valve is placed on the path of the refrigerant channel 10b. The outlet of the refrigerant passage 14a of the low-temperature-side heat exchanger 14 is connected to the compressor 11 by the refrigerant channel 10c. An accumulator 15 is placed on the path of the refrigerant channel 10d.

### <High-Temperature-Side Heat Medium Circuit>

The high-temperature-side heat medium circuit 20 includes the heat medium passage 12b of the above-described high-temperature-side heat exchanger 12, and a heater core 21 accommodated in a case 110 of the HVAC unit 100 and configured to heat air supplied into the vehicle cabin. The high-temperature-side heat medium circuit 20 is a circuit through which the heat medium heated by receiving heat from the refrigerant circuit 10 via the high-temperature-side heat exchanger 12 circulates. The high-temperature-side heat medium circuit 20 can be used to cause the heater core 21 to function to heat the inside of the vehicle cabin.

In the example shown in the figures, the elements of the high-temperature-side heat medium circuit 20 are connected by heat medium channels 20a, 20b, 20c. The inlet side 21a of the heater core 21 is connected to the outlet of the heat medium passage 12b of the high-temperature-side heat exchanger 12 by the heat medium channel 20a.

The inlet of the heat medium passage 12b of the high-temperature-side heat exchanger 12 is connected to the four-way valve V20 by the heat medium channel 20c. The outlet side 21b of the heater core 21 is connected to the four-way valve V20 by the heat medium channel 20b. On the path of the heat medium channel 20b, a circulation pump P20 that supplies the heat medium is placed. The heat medium is pushed out by the circulation pump P20, and circulates in the high-temperature-side heat medium circuit 20. The heat medium heated by receiving heat from the refrigerant circuit 10 when passing through the heat medium passage 12b of the high-temperature-side heat exchanger 12 is supplied to the heater core 21 from the inlet side 21a thereof, and passes through the heater core 21. At this time, the heat medium dissipates heat in the heater core 21, whereby the heater core 21 functions. The heat medium discharged from the outlet side 21b after having passed through the heater core 21 flows again toward the heat medium passage 12b of the high-temperature-side heat exchanger 12.

### <Low-Temperature-Side Heat Medium Circuit>

The low-temperature-side heat medium circuit 30 includes the heat medium passage 14b of the above-described low-temperature-side heat exchanger 14, a cooler core 31 accommodated in the case 110 of the HVAC unit 100 and configured to cool air supplied to the inside of the vehicle cabin, and a three-way valve V30 for switching the circuit. The low-temperature-side heat medium circuit 30 is a circuit through which the heat medium cooled by transferring heat to the refrigerant circuit 10 via the low-temperature-side heat exchanger 14 circulates. The low-temperature-side heat medium circuit 30 can be used to cause the cooler core 31 to function to cool or dehumidify the inside of the vehicle cabin.

Further, the channel of the low-temperature-side heat medium circuit 30, the channel of the battery temperature adjustment circuit 40, and the channel of the motor temperature adjustment circuit 50 can be connected to each other by the channel switching device 70. The low-temperature-side heat medium circuit 30 can also be used for temperature adjustment of a battery 41 and temperature adjustment of a motor 51 by forming the circulation path for circulating the heat medium in cooperation with the battery temperature adjustment circuit 40 and the motor temperature adjustment circuit 50. In other words, in this case, the exhaust heat of the battery 41 and the motor 51 can be used as the heat absorption source for the refrigerant circuit 10.

In the example shown in the figures, the elements of the low-temperature-side heat medium circuit 30 are connected by heat medium channels 30a, 30b, 30c, 30d, 30e, 30f. The outlet of the heat medium passage 14b of the low-temperature-side heat exchanger 14 and the three-way valve V30 are connected by the heat medium channel 30a, and the three-way valve V30 and the inlet side 31a of the cooler core 31 are connected by the heat medium channel 30b. When the three-way valve V30 connects these heat medium channels 30a, 30b, the outlet of the heat medium passage 14b of the low-temperature-side heat exchanger 14 and the inlet side 31a of the cooler core 31 are connected.

The outlet side 31b of the cooler core 31 is connected to the channel switching device 70 via the heat medium channel 30c connected thereto, a junction point, and the heat medium channel 30e downstream thereof. The three-way valve V30 and the junction point are connected by the heat medium channel 30d. When the cooler core 31 is disconnected by the three-way valve V30 and the outlet of the heat medium passage 14b of the low-temperature-side heat exchanger 14 and the channel switching device 70 are connected by the heat medium channels 30a, 30d, 30e, a bypass channel bypassing the cooler core 31 is formed.

The heat medium channel 30f connects the channel switching device 70 and the inlet of the heat medium passage 14b of the low-temperature-side heat exchanger 14. On the path of the heat medium channel 30f, a circulation pump P30 that supplies the heat medium is placed.

The channel of the low-temperature-side heat medium circuit 30 is connected to the channel of at least any one of the battery temperature adjustment circuit 40, the motor temperature adjustment circuit 50, or the outdoor heat exchange circuit 60 by the channel switching device 70, and can form the circulation path for circulating the heat medium in cooperation with at least any one of these circuits.

The heat medium circulates in the low-temperature-side heat medium circuit 30 by the circulation pump P30 placed on the path of the heat medium channel 30f. When passing through the heat medium passage 14b of the low-temperature-side heat exchanger 14, the heat medium is cooled by discharging heat to the refrigerant circuit 10. The cooled heat medium can be supplied to the cooler core 31 from the inlet side 31a and pass through the cooler core 31. At this time, the heat medium absorbs heat in the cooler core 31, whereby the cooler core 31 can function. The heat medium discharged from the outlet side 31b after having passed through the cooler core 31 or the heat medium having bypassed the cooler core 31 then passes through at least any one of the battery temperature adjustment circuit 40, the motor temperature adjustment circuit 50, or the outdoor heat exchange circuit 60 connected via the channel switching device 70, and flows again toward the heat medium passage 14b of the low-temperature-side heat exchanger 14.

### <Battery Temperature Adjustment Circuit>

The battery temperature adjustment circuit 40 includes the heat medium passage 14b of the above-described low-temperature-side heat exchanger 14 and the battery 41 as an in-vehicle device. The battery 41 is provided with a battery temperature adjuster for adjusting the temperature of the battery 41. The battery temperature adjustment circuit 40 can be used to adjust the temperature of the battery 41.

Note that a configuration similar to that of the battery temperature adjustment circuit 40 can be applied not only to the battery but also to other in-vehicle device temperature adjustment circuits having in-vehicle device temperature adjusters for temperature adjustment of other in-vehicle devices requiring temperature adjustment as well.

In the example shown in the figures, the elements of the battery temperature adjustment circuit 40 are connected by heat medium channels 40a, 40b. The inlet side 41a of the battery 41 is connected to the channel switching device 70 by the heat medium channel 40a. The outlet side 41b of the battery 41 is connected to the channel switching device 70 by the heat medium channel 40b.

The battery temperature adjustment circuit 40 can form a circulation path for independently circulating the heat medium by the channel switching device 70. The channel of the battery temperature adjustment circuit 40 is connected to the channel of at least any one of the low-temperature-side heat medium circuit 30, the motor temperature adjustment circuit 50, or the outdoor heat exchange circuit 60 by the channel switching device 70, and can form the circulation path for circulating the heat medium in cooperation with at least any one of these circuits.

On the path of the heat medium channel 40a, a circulation pump P40 and a heat medium heating device 42 are placed in this order from the upstream side. Even in a case where the battery temperature adjustment circuit 40 forms the circulation path independent of other circuits, or even in a case where no circulation pump is placed in a partner circuit that cooperatively forms the circulation path, the heat medium can be circulated by the circulation pump P40, and the temperature of the battery 41 can be adjusted.

### <Motor Temperature Adjustment Circuit>

The motor temperature adjustment circuit 50 includes the motor 51 as an in-vehicle device. The motor 51 is provided with a motor temperature adjuster for adjusting the temperature of the motor 51. The motor temperature adjustment circuit 50 can be used to circulate the heat medium to adjust the temperature of the motor 51. In addition, the thermal management system 1 can use, as a heat source, the motor 51 constantly generating heat during traveling or the like via the motor temperature adjustment circuit 50.

In the example shown in the figures, the elements of the motor temperature adjustment circuit 50 are connected by heat medium channels 50a, 50b. The inlet side 51a of the motor 51 is connected to the channel switching device 70 by the heat medium channel 50a. The outlet side 51b of the motor 51 is connected to the channel switching device 70 by the heat medium channel 50b. The channel of the motor temperature adjustment circuit 50 is connected to the channel of at least any one of the low-temperature-side heat medium circuit 30, the battery temperature adjustment circuit 40, or the outdoor heat exchange circuit 60 by the channel switching device 70, and can form the circulation path for circulating the heat medium in cooperation with at least any one of these circuits.

### <Outdoor Heat Exchange Circuit>

The outdoor heat exchange circuit 60 includes a radiator 61 as an outdoor heat exchanger. The outdoor heat exchange circuit 60 can be used to circulate the heat medium to exchange heat between the heat medium and the outside air.

In the example shown in the figures, the elements of the outdoor heat exchange circuit 60 are connected by heat medium channels 60a, 60b, 60c. The inlet side 61a of the radiator 61 is connected to the four-way valve V20 by the heat medium channel 60a. The channel switching device 70 and the four-way valve V20 are connected by the heat medium channel 60c. When the four-way valve V20 connects these two heat medium channels 60a, 60c, the inlet side 61a of the radiator 61 is connected to the channel switching device 70. The outlet side 61b of the radiator 61 is connected to the channel switching device 70 by the heat medium channel 60b.

The outdoor heat exchange circuit 60 can be disconnected from and independent of other circuits by the channel switching device 70. The channel of the outdoor heat exchange circuit 60 is connected to the channel of at least any one of the low-temperature-side heat medium circuit 30, the battery temperature adjustment circuit 40, or the motor temperature adjustment circuit 50 by the channel switching device 70, and can form the circulation path for circulating the heat medium in cooperation with at least any one of these circuits.

### <HVAC Unit>

As described above, the heater core 21 of the high-temperature-side heat medium circuit 20 and the cooler core 31 of the low-temperature-side heat medium circuit 30 are accommodated in the case 110 of the HVAC unit 100. The case 110 forms an outer shell of the HVAC unit 100, and forms an air flow passage 120 therein.

Further, the HVAC unit 100 has an intake unit 130. The intake unit 130 closes either an outside air suction port for introducing air outside the vehicle cabin or an inside air suction port for introducing air inside the vehicle cabin, and switches the air introduced into the case 110 to either the air outside the vehicle cabin (outside air introduction) or the air inside the vehicle cabin (inside air circulation). Further, the HVAC unit 100 further has a blower 140 placed adjacent to the intake unit 130 such that the air introduced into case 110 is fed to the air flow passage 120.

The cooler core 31 is placed upstream of the air flow passage 120. A heater core passage 121 and a bypass passage 122 are formed in parallel downstream of the air flow passage 120. The heater core 21 is provided on the heater core passage 121.

Thus, when the air introduced into the case 110 is guided to the heater core passage 121, the air is ventilated to the cooler core 31 and then to the heater core 21. On the other hand, when the air introduced into the case 110 is guided to the bypass passage 122, the air bypasses the heater core 21 after having been ventilated to the cooler core 31. A ratio between the air passing through the heater core passage 121 and the air passing through the bypass passage 122 is adjusted by an air mix damper 150.

### Operation of System

A specific operation of the thermal management system 1 according to the present embodiment will be described with reference to each figure.

### <Heating Operation (Startup/Below Appropriate Battery Temperature Range)>

FIG. 1 shows the state of the thermal management system 1 at the time of startup when an outside air temperature is low. At this time, the inside of the vehicle cabin is heated, and the battery 41 is warmed up.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

The low-temperature-side heat medium circuit 30 through which the heat medium having exchanged heat in the low-temperature-side heat exchanger 14 flows is set as follows. That is, the three-way valve V30 forms the heat medium channels 30a. 30d, 30e such that the heat medium cooled by the heat exchange in the low-temperature-side heat exchanger 14 flows so as to bypass the cooler core 31. The channel switching device 70 connects the channels of the low-temperature-side heat medium circuit 30 and the outdoor heat exchange circuit 60 to each other, and forms the circulation path in which the low-temperature-side heat medium circuit 30 and the outdoor heat exchange circuit 60 cooperate to circulate the heat medium. That is, the heat medium channels 30a, 30d, 30e of the low-temperature-side heat medium circuit 30 and the heat medium channels 60a, 60b passing through the radiator 61 are connected, and the heat medium circulates through this circulation path. As a result, the heat medium having exchanged heat in the low-temperature-side heat exchanger 14 passes through the radiator 61, and exchanges heat with the outside air. As described above, the refrigerant circuit 10 operates using the heat of the heat medium absorbed from the outside air in the radiator 61 as a heat absorption source, and the air-conditioning in the vehicle cabin is performed as the outside air heat absorption heating.

The channel switching device 70 connects the channels of the battery temperature adjustment circuit 40 and the motor temperature adjustment circuit 50 to each other, and forms the circulation path in which the battery temperature adjustment circuit 40 and the motor temperature adjustment circuit 50 cooperate to circulate the heat medium. That is, the heat medium channels 50a, 50b passing through the motor 51 and the heat medium channels 40a, 40b passing through the battery 41 are connected, and the heat medium circulates through this circulation path. As a result, the battery 41 is warmed up by the heat medium heated by the heat generated by the motor 51. The exhaust heat of the motor 51 is effectively used for warming up the battery 41, thereby achieving power saving.

At this time, if necessary, the heat medium circulating on the path of the heat medium channel 40a of the battery temperature adjustment circuit 40, that is, by the heat medium heating device 42 placed upstream of the circulation path with respect to the battery 41, may be heated. As a result, the time required for completing the warm-up of the battery 41 can be shortened. However, for example, in environment where the outside air temperature is not so low as in, for example, an intermediate period, if the warm-up of the battery 41 can be completed in a short time only by self-heating of the battery 41 and the exhaust heat of the motor 51, the heating of the heat medium by the heat medium heating device 42 can be omitted.

As described above, by switching the channel switching device 70 to make the air-conditioning circuit for adjusting the temperature in the vehicle cabin, to which the low-temperature-side heat medium circuit 30 and the outdoor heat exchange circuit 60 are connected, and the battery warm-up circuit to which the battery temperature adjustment circuit 40 and the motor temperature adjustment circuit 50 are connected independent of each other, it is possible to easily manage the temperature of the battery 41 and warm up the battery 41.

### <Heating Operation (Appropriate Battery Temperature Range)>

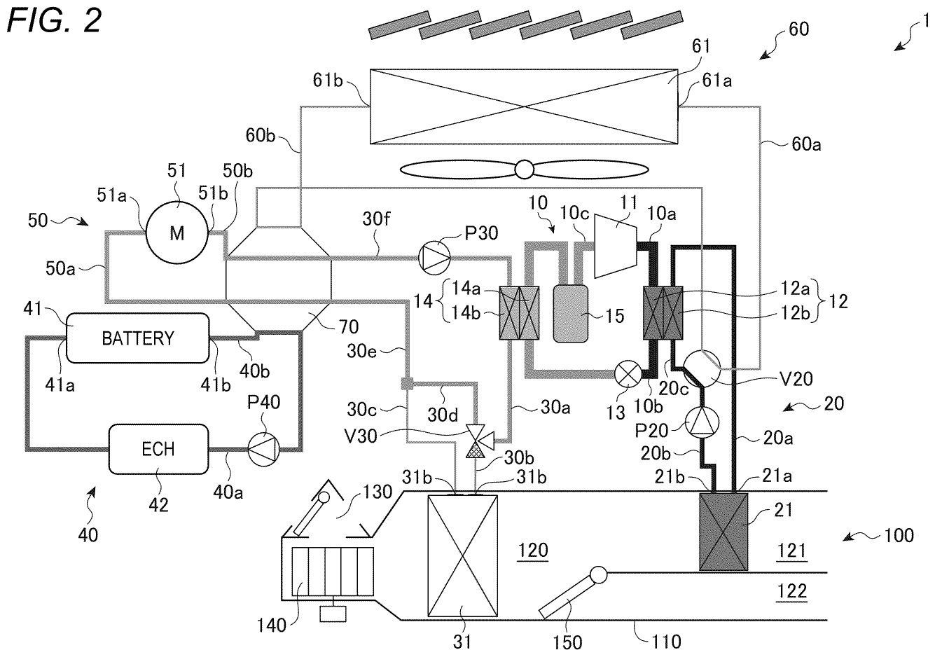

FIG. 2 shows the state of the thermal management system 1 when the outside air temperature is low and after the warm-up of the battery 41 has been completed and the battery 41 has reached an appropriate temperature range. The appropriate temperature range of the battery 41 is, for example, 25±5° C. or the like. That is, FIG. 2 shows the state in which the temperature of the battery 41 is equal to or higher than a predetermined lower limit such as 20° C. At this time, the inside of the vehicle cabin is heated. Moreover, the battery 41 is subjected to temperature management by self-heating.

The channel switching device 70 causes the battery temperature adjustment circuit 40 to independently form the circulation path of the heat medium. Since the battery 41 also generates heat, the temperature of the battery 41 is adjusted by adjusting the flow rate of the heat medium circulating through the battery temperature adjustment circuit 40. At this time, the heat medium may be heated by the heat medium heating device 42 if necessary.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

The low-temperature-side heat medium circuit 30 through which the heat medium having exchanged heat in the low-temperature-side heat exchanger 14 flows is set as follows. That is, the three-way valve V30 forms the heat medium channels 30a, 30d, 30e such that the heat medium cooled by the heat exchange in the low-temperature-side heat exchanger 14 flows so as to bypass the cooler core 31. The channel switching device 70 connects the channels of the low-temperature-side heat medium circuit 30 and the motor temperature adjustment circuit 50 to each other, and forms the circulation path in which the low-temperature-side heat medium circuit 30 and the motor temperature adjustment circuit 50 cooperate to circulate the heat medium. That is, the heat medium channels 30a, 30d, 30e of the low-temperature-side heat medium circuit 30 and the heat medium channels 50a, 50b passing through the motor 51 are connected, and the heat medium circulates through this circulation path. As a result, the refrigerant circuit 10 operates using the heat of the heat medium heated by the heat generated in the motor 51 as a heat absorption source, and the air-conditioning in the vehicle cabin is performed as the heating.

For example, in the environment where the outside air temperature is not so low as in the intermediate period, in a case where the heating operation can be performed only by the exhaust heat of the motor 51, as shown in FIG. 2, the channel switching device 70 and the four-way valve V20 causes the outdoor heat exchange circuit 60 to independently form the circulation path of the heat medium. Since the outside air heat absorption is not performed by the outdoor heat exchange circuit 60, frosting on the radiator 61 can be avoided. In addition, driving of a radiator fan is unnecessary, and power consumption of the battery 41 can be reduced.

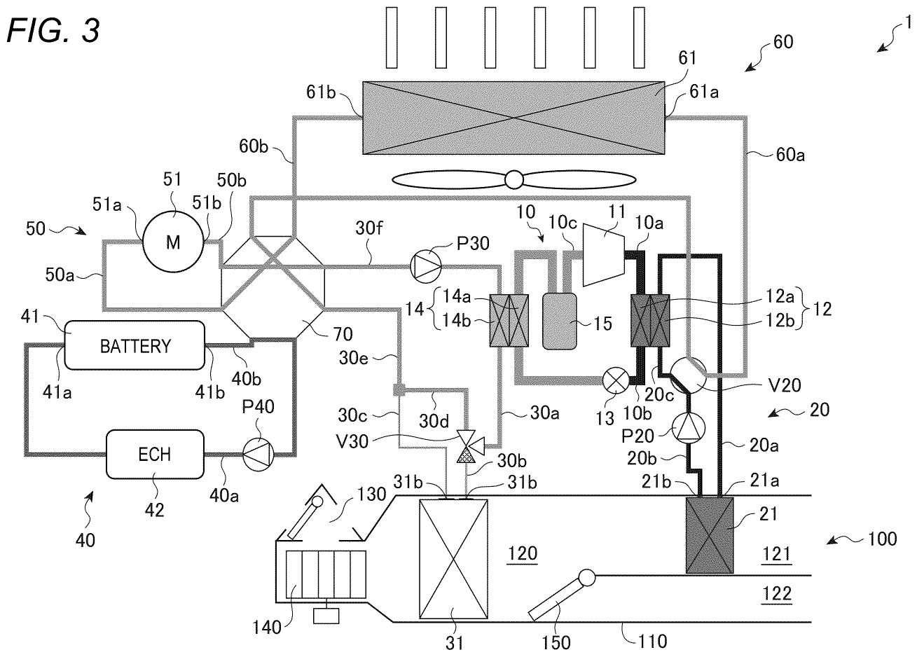

In a case where the heating operation cannot be performed only by the exhaust heat of the motor 51, as shown in FIG. 3, the channel switching device 70 connects the channels of the low-temperature-side heat medium circuit 30, the outdoor heat exchange circuit 60, and the motor temperature adjustment circuit 50 to each other, and forms the circulation path in which the low-temperature-side heat medium circuit 30, the outdoor heat exchange circuit 60, and the motor temperature adjustment circuit 50 cooperate to circulate the heat medium. That is, the heat medium channels 30f, 30a, 30d, 30e of the low-temperature-side heat medium circuit 30, the heat medium channels 60a, 60b, 60c of the outdoor heat exchange circuit 60 passing through the radiator 61, and the heat medium channels 50a, 50b of the motor temperature adjustment circuit 50 passing through the motor 51 are connected, and the heat medium circulates through this circulation path. As a result, the refrigerant circuit 10 is operated by the heat of the heat medium having absorbed heat from the outside air in the radiator 61 and further absorbed the exhaust heat of the motor 51. Also in this case, the motor 51 may mainly serve as a heat source. As a result, the frosting on the radiator 61 is reduced.

As described above, the channel switching device 70 is switched to connect at least the low-temperature-side heat medium circuit 30 and the motor temperature adjustment circuit 50, and the exhaust heat of the motor 51 is effectively used without loss by using the motor exhaust heat as a heat absorption source for the heating operation, whereby power saving is achieved.

### <Heating Operation (Increased Battery Temperature)>

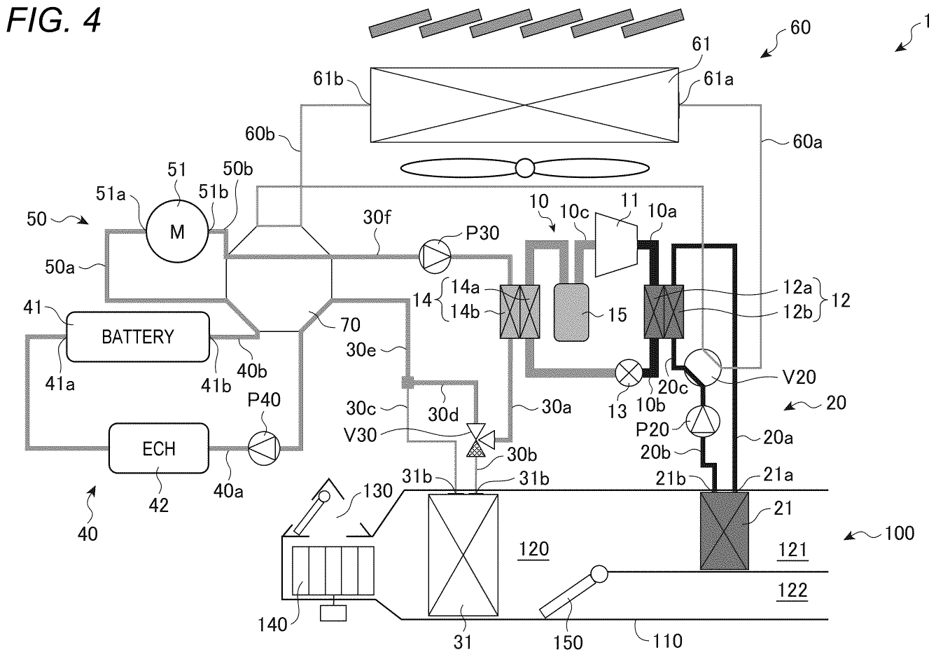

FIG. 4 shows the state of the thermal management system 1 when the outside air temperature is low and the temperature of the battery 41 increases and is about to exceed the upper limit of the appropriate temperature range. The upper limit of the appropriate temperature range of the battery 41 is, for example, 45+5° C. or the like.

That is, FIG. 4 shows the state when the temperature of the battery 41 is equal to or higher than a predetermined upper limit such as 40° C. At this time, the inside of the vehicle cabin is heated. Moreover, the battery 41 is cooled.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

The low-temperature-side heat medium circuit 30 through which the heat medium having exchanged heat in the low-temperature-side heat exchanger 14 flows is set as follows. That is, the three-way valve V30 forms the heat medium channels 30a, 30d. 30e such that the heat medium cooled by the heat exchange in the low-temperature-side heat exchanger 14 flows so as to bypass the cooler core 31. The channel switching device 70 connects the channels of the low-temperature-side heat medium circuit 30, the battery temperature adjustment circuit 40, and the motor temperature adjustment circuit 50 to each other, and forms the circulation path in which the low-temperature-side heat medium circuit 30, the battery temperature adjustment circuit 40, and the motor temperature adjustment circuit 50 cooperate to circulate the heat medium. That is, the heat medium channels 30a, 30d, 30e of the low-temperature-side heat medium circuit 30, the heat medium channels 40a, 40b passing through the battery 41, and the heat medium channels 50a, 50b passing through the motor 51 are connected, and the heat medium circulates through this circulation path.

As a result, the refrigerant circuit 10 operates using the heat generated in the battery 41 and the heat of the heat medium heated by the heat generated in the motor 51 as a heat absorption source, and the air-conditioning in the vehicle cabin is performed as the heating. The heat medium of the battery temperature adjustment circuit 40 exchanges heat with the refrigerant circuit 10 in the low-temperature-side heat exchanger 14, and is cooled. The battery 41 is cooled by the cooled heat medium. As described above, the heating operation can be continued by effectively using the motor exhaust heat as the heat absorption source while the battery 41 is cooled.

In FIG. 4, in a case where the channel switching device 70 is switched to connect the low-temperature-side heat medium circuit 30, the battery temperature adjustment circuit 40, and the motor temperature adjustment circuit 50, the heat medium flows through the low-temperature-side heat medium circuit 30, the battery temperature adjustment circuit 40, and the motor temperature adjustment circuit 50 in this order considering that the amount of heat generated by the motor 51 is larger than the amount of heat generated by the battery 41. As a result, the heat medium heated by the exhaust heat of the battery 41 and the exhaust heat of the motor 51 exchanges heat with the refrigerant circuit 10 in the low-temperature-side heat exchanger 14 and is cooled, and then flows through the battery temperature adjustment circuit 40. As a result, the battery 41 is efficiently cooled.

Although not shown in the figures, in a case where the cooling of the battery 41 is preferentially performed, the channel switching device 70 connects the channels of the low-temperature-side heat medium circuit 30 and the battery temperature adjustment circuit 40 to each other, and forms the circulation path in which the low-temperature-side heat medium circuit 30 and the battery temperature adjustment circuit 40 cooperate to circulate the heat medium. That is, the heat medium channels 30a, 30d, 30e of the low-temperature-side heat medium circuit 30 and the heat medium channels 40a, 40b passing through the battery 41 are connected, and the heat medium circulates through this circulation path. As a result, the heat medium of the battery temperature adjustment circuit 40 exchanges heat with the refrigerant circuit 10 in the low-temperature-side heat exchanger 14 without passing through the motor temperature adjustment circuit 50, and is further cooled by an amount not heated by the exhaust heat of the motor 51. The cooling of the battery 41 can be preferentially performed by this cooled heat medium.

As described above, the channel switching device 70 is switched to connect at least the low-temperature-side heat medium circuit 30 and the battery temperature adjustment circuit 40, and the heat medium of the battery temperature adjustment circuit 40 is cooled, whereby the battery 41 can be cooled.

When the battery 41 is cooled and the temperature of the battery 41 decreases and is about to exceed the lower limit of the appropriate temperature range, the thermal management system 1 switches the channel switching device 70 to the state shown in FIG. 2 or 3. In short, the thermal management system 1 switches the channel switching device 70 such that the exhaust heat is effectively used without loss while the temperature of the battery 41 is maintained in the appropriate temperature range while monitoring the temperature of the battery 41 and the temperature of the motor 51.

### <Heating Operation (Defrosting During Traveling)>

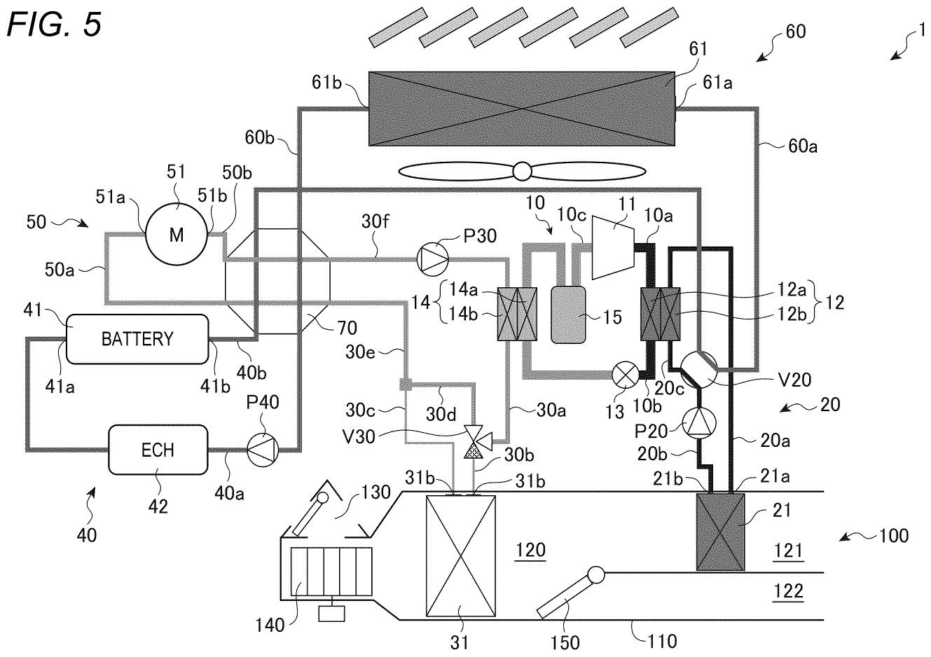

FIG. 5 shows the state of the thermal management system 1 when defrosting of the radiator 61 and the heating operation of the inside of the vehicle cabin are performed during traveling.

The high-temperature-side heat medium circuit 20 through which the heat medium having exchanged heat in the high-temperature-side heat exchanger 12 flows is set as follows. That is, the four-way valve V20 connects the heat medium channels 20b, 20c such that the heat medium heated by the heat exchange in the high-temperature-side heat exchanger 12 circulates through the high-temperature-side heat medium circuit 20 disconnected from the outdoor heat exchange circuit 60 and flows through the heater core 21. As a result, the inside of the vehicle cabin is heated by the heat of the heat medium absorbed in the high-temperature-side heat exchanger 12.

The low-temperature-side heat medium circuit 30 through which the heat medium having exchanged heat in the low-temperature-side heat exchanger 14 flows is set as follows. That is, the three-way valve V30 forms the heat medium channels 30a, 30d, 30e such that the heat medium cooled by the heat exchange in the low-temperature-side heat exchanger 14 flows so as to bypass the cooler core 31. The channel switching device 70 connects the channels of the low-temperature-side heat medium circuit 30 and the motor temperature adjustment circuit 50 to each other, and forms the circulation path in which the low-temperature-side heat medium circuit 30 and the motor temperature adjustment circuit 50 cooperate to circulate the heat medium. That is, the heat medium channels 30a, 30d, 30e of the low-temperature-side heat medium circuit 30 and the heat medium channels 50a, 50b passing through the motor 51 are connected, and the heat medium circulates through this circulation path. As a result, the refrigerant circuit 10 operates using the heat of the heat medium heated by the heat generated in the motor 51 as a heat absorption source, and the air-conditioning in the vehicle cabin is performed as the heating.

The channel switching device 70 connects the channels of the battery temperature adjustment circuit 40 and the outdoor heat exchange circuit 60 to each other, and forms the circulation path in which the battery temperature adjustment circuit 40 and the outdoor heat exchange circuit 60 cooperate to circulate the heat medium. That is, the heat medium channels 40a, 40b passing through the battery 41 and the heat medium channels 60a, 60b passing through the radiator 61 are connected, and the heat medium circulates through this circulation path. As a result, the radiator 61 is defrosted by the heat medium heated by the heat generated in the battery 41.

As described above, the channel switching device 70 is switched to independently connect the motor temperature adjustment circuit 50 and the battery temperature adjustment circuit 40 to the low-temperature-side heat medium circuit 30 and the outdoor heat exchange circuit 60, respectively, the exhaust heat of the motor 51 and the exhaust heat of the battery 41 different in the amount of heat generated can be effectively used. That is, the low-temperature-side heat medium circuit 30 and the motor temperature adjustment circuit 50 are connected, and the heating operation can be continued using the exhaust heat of the motor 51 having a large amount of heat generated. Although the amount of heat generated by the battery 41 is smaller than the amount of heat generated by the motor 51, it is sufficient to defrost the radiator 61. Thus, the battery temperature adjustment circuit 40 and the outdoor heat exchange circuit 60 are connected, and the radiator 61 can be defrosted using the exhaust heat of the battery 41. At this time, the temperature of the battery 41 can also be adjusted by cooling the battery 41 with the heat medium cooled by the defrosting of the radiator 61.

In a situation where the radiator 61 is defrosted during traveling, it is assumed that the outside air heat absorption heating is performed under a condition where frost is already formed on the radiator 61 and the temperature in the vehicle cabin is adjusted to be around a target temperature. Thus, even if the heating operation is performed only by the exhaust heat of the motor 51, a heating request is satisfied, and the defrosting can be performed while maintaining comfort in the vehicle cabin. At this time, preferably, the intake unit 130 of the case 110 of the HVAC unit 100 closes the outside air suction port for introducing the air outside the vehicle cabin, and switches to the inside air circulation for introducing the air inside the vehicle cabin into the case 110. As a result, it is possible to avoid introduction of the low-temperature outside air into the vehicle cabin and to prevent degradation of the comfort in the vehicle cabin.

### System

According to the thermal management system 1 of the present embodiment, it is possible to effectively use the exhaust heat of the motor 51 and the like without loss while appropriately switching the circuit according to the heating request, air-conditioning request, and the like for the battery 41. For example, when it is necessary to increase the temperature of the battery 41 at the time of startup, the battery 41 can be warmed up using the exhaust heat of the motor 51. When it is not necessary to warm up the battery 41, the exhaust heat of the motor 51 and, if necessary, the exhaust heat of the battery 41 can also be used for heating. While the heating operation is continued using the exhaust heat of the motor 51, the radiator 61 can also be defrosted using the exhaust heat of the battery 41.

In the thermal management system 1, the battery temperature adjustment circuit 40 and the air-conditioning circuit for adjusting the temperature in the vehicle cabin can be independent of each other, and therefore, for example, the influence of the heating of the battery 41 on the heating can be reduced.

Although the present invention has been described with reference to the preferred embodiments, the present invention is not limited only to the above-described embodiments, and it goes without saying that various modifications can be made within the scope of the present invention.

### LIST OF REFERENCE SIGNS

1 Thermal management system
10 Refrigerant circuit
11 Compressor
12 High-temperature-side heat exchanger
13 Decompression device
14 Low-temperature-side heat exchanger
15 Accumulator
20 High-temperature-side heat medium circuit
21 Heater core
P20 Circulation pump
V20 Four-way valve
30 Low-temperature-side heat medium circuit
31 Cooler core
P30 Circulation pump
V30 Three-way valve
40 Battery temperature adjustment circuit
41 Battery
P40 Circulation pump
50 Motor temperature adjustment circuit
51 Motor
60 Outdoor heat exchange circuit
61 Radiator
70 Channel switching device
100 HVAC unit
110 Case
120 Air flow passage
121 Heater core passage
122 Bypass passage
150 Air mix damper

1. A thermal management system comprising:
a refrigerant circuit configured to circulate refrigerant and including a compressor, a high-temperature-side heat exchanger, a decompression device, and a low-temperature-side heat exchanger;
a high-temperature-side heat medium circuit including a heater core that heats air supplied into a vehicle cabin and configured to circulate a heat medium capable of exchanging heat with the refrigerant via the high-temperature-side heat exchanger;
a low-temperature-side heat medium circuit including a cooler core that cools air supplied into the vehicle cabin and configured to circulate a heat medium capable of exchanging heat with the refrigerant via the low-temperature-side heat exchanger;
a battery temperature adjustment circuit including a battery temperature adjuster that adjusts a temperature of a battery;
a motor temperature adjustment circuit including a motor temperature adjuster that adjusts a temperature of a motor;
an outdoor heat exchange circuit including a radiator and configured to circulate a heat medium; and
a channel switching device configured to switch the low-temperature-side heat medium circuit, the battery temperature adjustment circuit, the motor temperature adjustment circuit, and the outdoor heat exchange circuit between a connection state and an independent state, wherein
at a time of startup, when the temperature of the battery is a predetermined lower limit or less, the channel switching device connects the low-temperature-side heat medium circuit and the outdoor heat exchange circuit, and
connects the battery temperature adjustment circuit and the motor temperature adjustment circuit.

2. The thermal management system according to claim 1, wherein
when the temperature of the battery is a predetermined lower limit or more, the channel switching device
connects at least the low-temperature-side heat medium circuit and the motor temperature adjustment circuit.

3. The thermal management system according to claim 1, wherein
when the temperature of the battery is a predetermined upper limit or more, the channel switching device
connects at least the low-temperature-side heat medium circuit and the battery temperature adjustment circuit.

4. The thermal management system according to claim 1, wherein
when connecting the low-temperature-side heat medium circuit, the battery temperature adjustment circuit, and the motor temperature adjustment circuit,
the channel switching device
switches a channel such that a heat medium flows through the low-temperature-side heat medium circuit, the battery temperature adjustment circuit, and the motor temperature adjustment circuit in this order.
